(19) United States
(12) Patent Application Publication
(10) Pub. No.: US 2018/0239575 A1
(43) Pub. Date: Aug. 23, 2018

(54) MOBILE APPLICATION FUNCTION SHARING THROUGH NEAR FIELD COMMUNICATION

(71) Applicant: International Business Machines Corporation, Armonk, NY (US)

(72) Inventors: Ming Jin Chen, Ningbo (CN); Liang Liang Tang, Ningbo (CN); Zu Long Wang, Ningbo (CN); Yin Jun Zhang, Ningbo (CN); Hong Yin Zhu, Ningbo (CN)

(21) Appl. No.: 15/439,995

(22) Filed: Feb. 23, 2017

(51) Int. Cl. G06F 3/14; H04W 4/00; G09G 5/00

(52) U.S. Cl. CPC G06F 3/1454; G09G 2370/16; G09G 5/006; H04W 4/008

(57) ABSTRACT

The disclosure is directed to mobile application function sharing. A system according to embodiments includes: a plurality of mobile devices; and an application on each of the mobile devices; wherein the application on each of the mobile devices includes a share context framework, including: a view interface for generating a share context including a sequence of page views of content of the application; a sender interface for transmitting the generated share context directly to the application on another of the plurality of mobile devices; a receiver interface for receiving, directly from the application on another of the plurality of mobile devices, a share context including a sequence of page views of content of the application on the other mobile device; and an executor for rendering in the application the sequence of page views included in the received share context.

### TECHNICAL FIELD

The present invention relates generally to mobile devices, and more particularly, to mobile application function sharing through near field communication (NFC).

### BACKGROUND

It is often necessary to share the content of an application on one mobile device with the same application on a second mobile device. A typical process for sharing the content includes:

1) A first user selects content to be shared in Application A running on a first user's mobile device;
2) The first user selects Application B and sends the share content (or a link for accessing the content) to a second user's mobile device using Application B;
3) The second user opens the link using Application B or another compatible application running on the second user's mobile device; and
4) The second user views the share content using Application A running on the second user's mobile device.

The above-described multi-step process requires that Application B (or compatible application) is available on the second user's mobile device. Further, in the testing of mobile devices, this process makes it difficult to reproduce a “bug” in Application A on different mobile devices, even when performing the same manual user actions (e.g., sequence of operations).

### SUMMARY

A first aspect of the invention provides a system for mobile application function sharing, including: a plurality of mobile devices; and an application on each of the mobile devices; wherein the application on each of the mobile devices includes a share context framework, including: a view interface for generating a share context including a sequence of page views of content of the application; a sender interface for transmitting the generated share context directly to the application on another of the plurality of mobile devices; a receiver interface for receiving, directly from the application on another of the plurality of mobile devices, a share context including a sequence of page views of content of the application on the other mobile device; and an executor for rendering in the application the sequence of page views included in the received share context.

A second aspect of the invention provides a system for mobile application function sharing, including: a plurality of mobile devices; and an application on each of the mobile devices; wherein the application on each of the mobile devices includes a share context framework for: generating a share context including a sequence of page views of content of the application; and transmitting the generated share context directly to the application on another of the plurality of mobile devices via near field communication.

A third aspect of the invention provides a method for mobile application function sharing, including: generating, on a first mobile device, a share context including a sequence of page views of content of an application on the first mobile device; and transmitting the generated share context directly to the same application on a second mobile device via near field communication.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description taken in conjunction with the accompanying drawings that depict various aspects of the invention.

FIG. 1 depicts the sharing of content between mobile devices using mobile application function sharing via near field communication (NFC) according to embodiments.

FIG. 2 depicts the sharing of content between mobile devices using near field communication (NFC) according to embodiments.

FIG. 3 depicts the building of a share context by a view interface according to embodiments.

FIG. 4 depicts a share context according to embodiments.

FIG. 5 depicts a sender interface according to embodiments.

FIG. 6 depicts a receiver interface according to embodiments.

FIG. 7 depicts an executor according to embodiments.

FIG. 8 depicts a processing system according to embodiments.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

The present invention relates generally to mobile devices, and more particularly, to mobile application function sharing through near field communication (NFC). Advantageously, instead of sharing content of a primary application between a plurality of mobile devices using a secondary application, content is directly shared between the mobile devices (i.e., peer to peer) by the primary application via NFC. Further, by sharing content in this manner, user actions (e.g., sequence of operations) can be reproduced between mobile devices (e.g., during application testing).

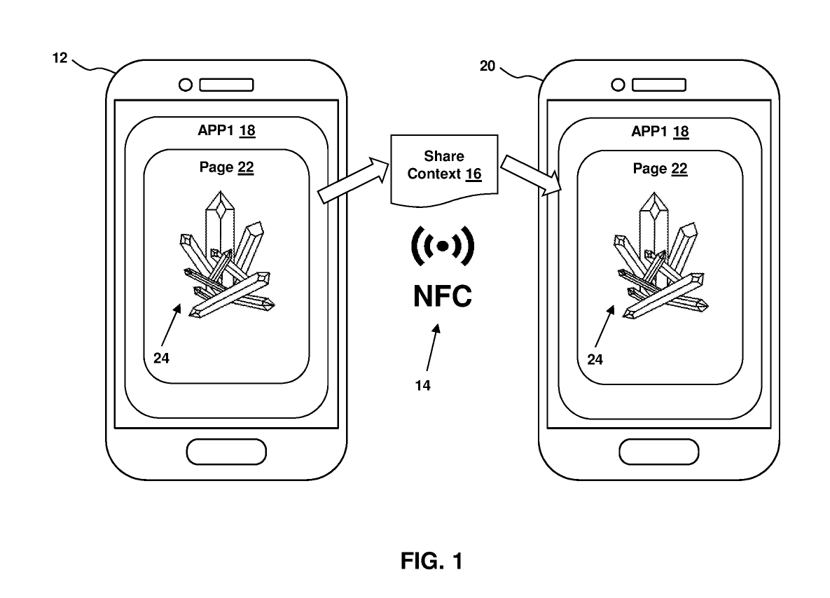

A system for mobile application function sharing between a plurality of mobile devices (2 in this example) through NFC is depicted in FIG. 1.

FIG. 1 shows a first mobile device 12 using NFC 14 to send a share context 16 generated by an application 18 (“APP1 18”) running on the first mobile device 12 to the same APP1 18 running on a second mobile device 20. In this simple example, a page 22 containing an image 24 of a crystal generated by the APP1 18 is communicated in the share context 16 via NFC 14 from the first mobile device 12 directly to the APP1 18 running on to the second mobile device 20. The page 22 containing the image 24 is reproduced by the APP1 18 in the second mobile device 20.

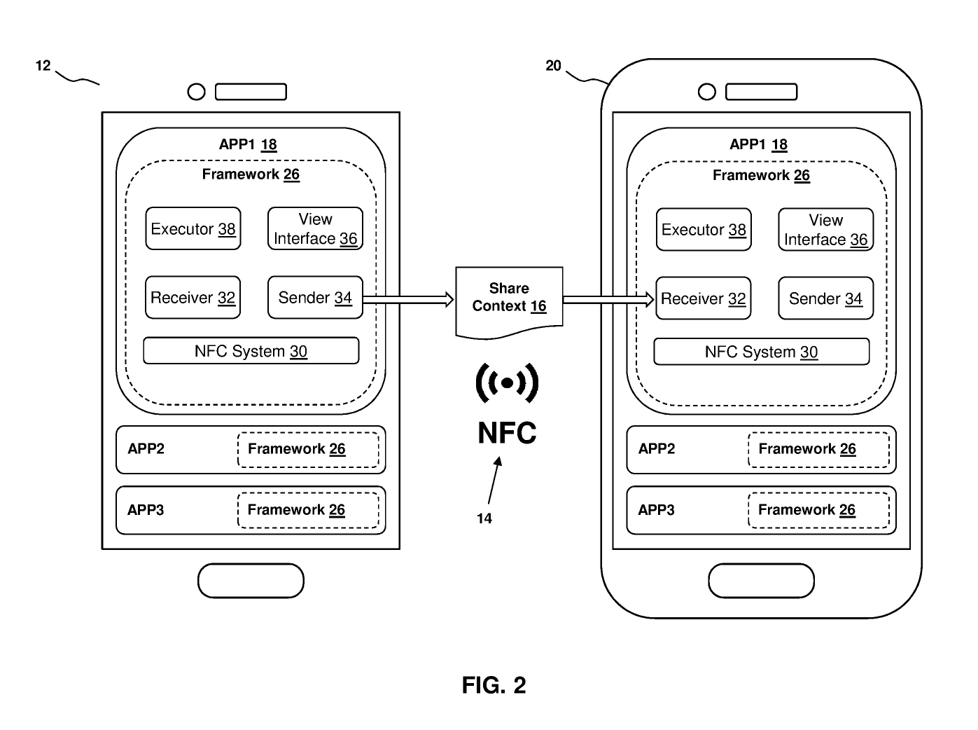

In general, according to embodiments, each page 22 has a related view. A page view mapping entry is created and stored in the share context 16 for each page 22 in a set (i.e., one or more) of pages 22 that are to be shared from the sending mobile device (e.g., mobile device 12) to one or more receiving mobile devices (e.g., mobile device 20). The share context 16 also stores page view data for each page 22, including parameters for each page 22. The APP1 18 in each mobile device 12, 20 includes a share context framework 26 (FIG. 2), which is configured to generate and parse share context 16. The share context 16 and share context framework 26 are presented in greater detail below. Other applications (e.g., APP2, APP3, FIG. 2) in each mobile device 12, 20 may also include an associated share context framework 26 for generating and parsing a respective share context 16 to enable those applications to share content between the mobile devices 12, 20 as described herein.

The share context framework 26 for APP1 18 is shown in greater detail in FIG. 2. The share context framework 26 for other applications (e.g., APP2, APP3) has the same structure and functionality.

According to embodiments, the share context framework 26 is a common application framework that enables context sharing (e.g., via the share context 16) of page views between an application (e.g., APP1, APP2, APP3, FIG. 2) installed on different mobile devices. The share context framework 26 generally includes an NFC system 30, a receiver interface 32, a sender interface 34, a view interface 36, and an executor 38. The NFC system 30 is used to send and receive data (e.g., a share context 16) via NFC. As known in the art, NFC is a set of communication protocols that enable two electronic devices to establish communication by bringing the electronic devices within a short distance (e.g., several centimeters) from each other.

The receiver interface 32 of a mobile device is configured to receive via NFC a share context 16 generated by the view interface 36 of another mobile device. The receiver interface 32 validates the share context 16 and determines whether the executor 38 should be triggered. In FIG. 2, for example, the receiver interface 32 of the mobile device 20 receives via NFC a share context 16 generated by the view interface 36 of mobile device 12.

The sender interface 34 of a mobile device is configured to send via NFC a share context 16 generated by the view interface 36 of a mobile device. In FIG. 2, for example, the sender interface 34 of the mobile device 12 sends via NFC a share context 16 generated by the view interface 36 of mobile device 12. The generation and/or sending of a share context 16 by a sender interface 34 may be triggered, for example, by certain user action(s) in an application (e.g., APP1) running on a mobile device. For example, a user may actuate an interface element (e.g., a button, menu item, and/or the like) in an application to generate and/or send a share context 16. Further, a user may perform a physical action (e.g., shake a mobile device, press a button on a mobile phone, etc.) to send a share context 16. Any other suitable mechanism for triggering the sending of the share context 16 may, of course, be used.

The executor 38 of a mobile device is configured to execute a sequence of page views included in a share context 16 received by the receiver interface 32 of a mobile device. In FIG. 2, for example, the executor 38 of the mobile device 20 executes the sequence of page views included in the share context 16 received by the receiver interface 32 of the mobile device 20.

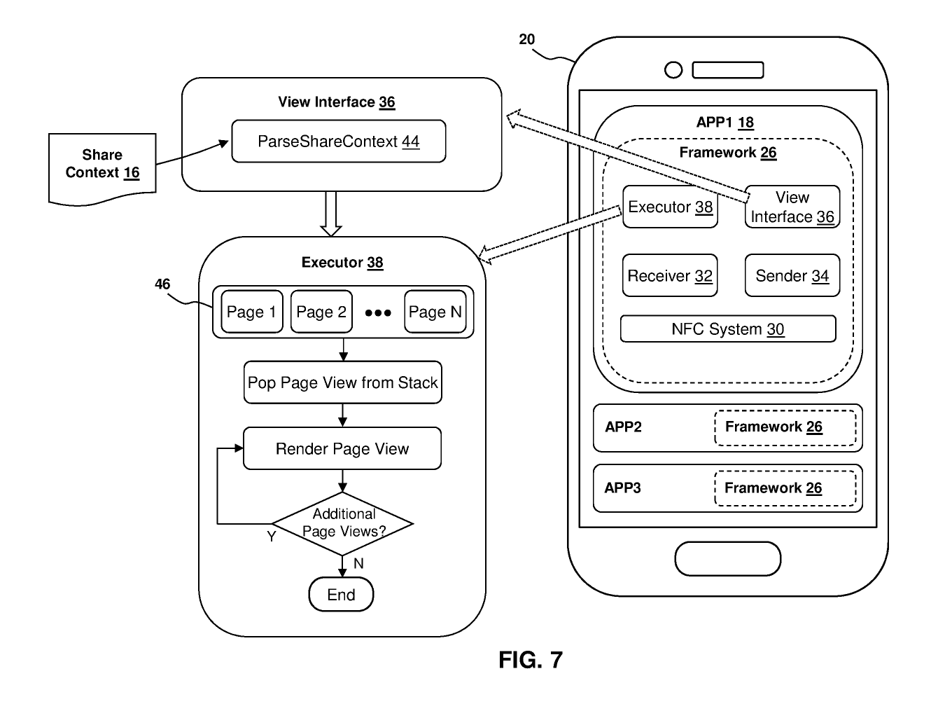

In general, the executor 38 is triggered by the receipt of a share context 16 by the receiver interface 32 of a mobile device. In FIG. 2, for example, the executor 38 of the mobile device 20 is triggered by the receipt of the share context 16 by the receiver interface 32 of the mobile device 20. The executor 38 in conjunction with the view interface 36 parses the share context 16 to generate a sequence of page views using a “ParseShareContext” interface 44 (FIG. 7). The executor 38 subsequently renders the page views in the application on the mobile device (e.g., in APP1 on mobile device 20).

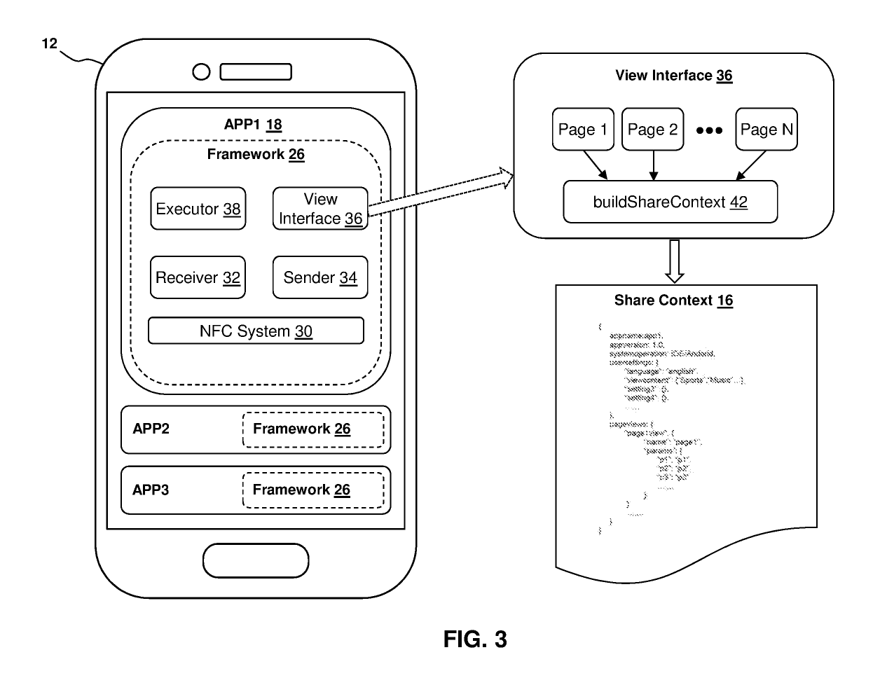

According to embodiments, the share context 16 includes page view data for each page, page view sequence data, user personal settings, system language, system operation (e.g., IOS/Android), application version, and other application and/or page-related data. The share context 16 may be generated by the view interface 36 as shown for example in FIG. 3, where each page in APP1 implements a “BuildShareContext” interface 42. The first page in the share context 16 (e.g., Page 1 in the page sequence Page 1, Page 2, . . . , Page N in FIG. 3) stores the application version, system operation, and user settings. All of the pages in the share context 16 (e.g., Page 1, Page 2, . . . , and Page N in FIG. 3) store the name of the page and parameters associated with the page.

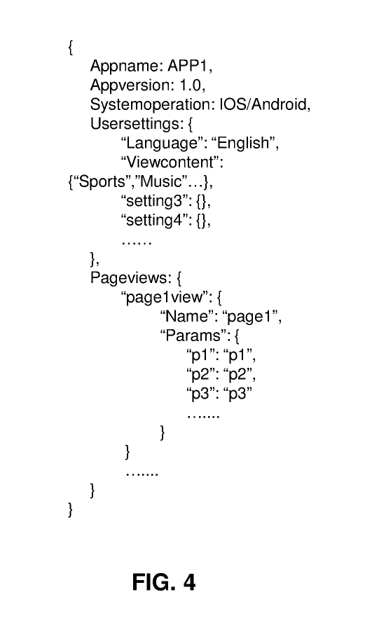

An example of a share context 16 according to embodiments is depicted in FIG. 4. In this example, the name of the application (“Appname”) is APP1, the version of APP1 (“Appversion”) is 1.0, and the operating system(s) (“Systemoperation”) of the mobile devices include IOS or Android. Successful sharing of a share context 16 having an Appname, Appversion, and Systemoperation will generally be possible when the sharing applications in mobile devices have the same Appname, Appversion, and Systemoperation as in the share context 16. However, if the Appname, Appversion, and/or Systemoperation do not all match, a sharing failure may occur. Data regarding such a mismatch may be useful for example during application testing and troubleshooting.

With continued reference to the share context 16 depicted in FIG. 4, the “Usersettings” sets forth a user's personal settings in an application, such as language, viewcontent, and/or the like. “Pageviews” contains a sequence of pageviews, where each pageview contains the name and parameters of a page to be rendered on the receiving mobile device.

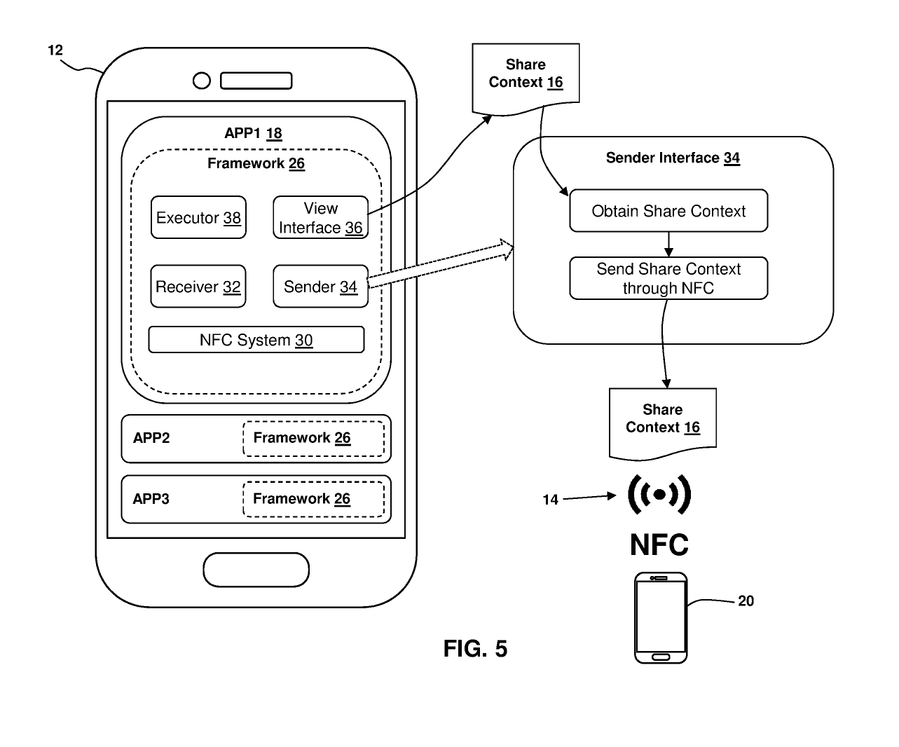

The operation of the sender interface 34 is depicted in FIG. 5. The sender interface 34 obtains the share context 16 generated by the view interface 36 of the share context framework 26 of an application (e.g. APP1 on mobile device 12). After obtaining the share context 16, the sender interface 34 interacts with the NFC system 30 to transmit the share context 16 via NFC 14 to a nearby mobile device (e.g., mobile device 20).

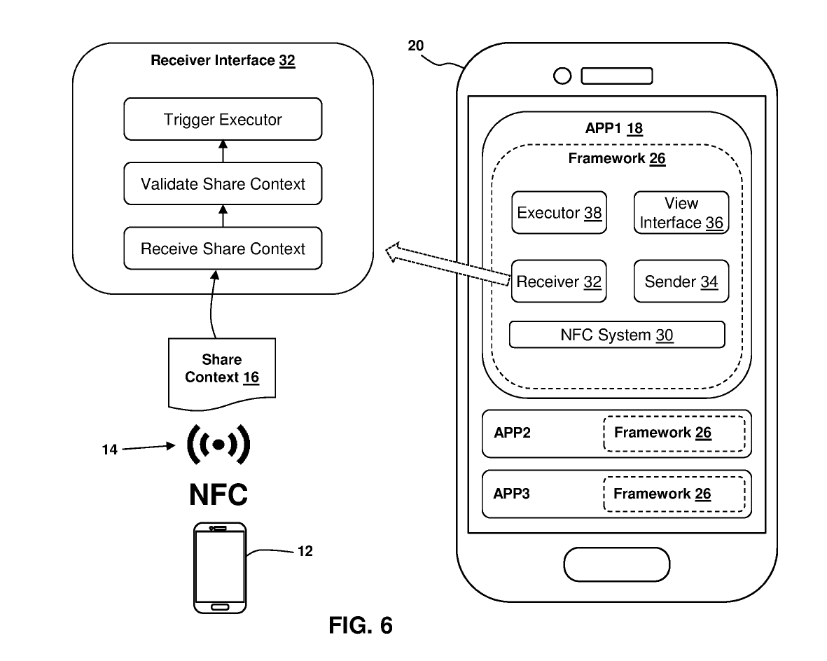

The operation of the receiver interface 32 is depicted in FIG. 6. Upon receipt of the share context 16 via NFC 14, the receiver interface 32 may validate the format of the share context 16. This may be done, for example, using Appversion matching and Operationsystem matching. Once the share context 16 has been validated, the receiver interface 32 triggers the executor 38.

Once triggered, as depicted in FIG. 7, the executor 38 receives a stack 46 of page views from the view interface 36, which has parsed the share context 16 using a “ParseShareContext” interface 44. The executor 38 subsequently “pops” a page view of the first page (e.g., Page 1) from the stack 46 and renders the page view on in the application based on the Usersettings set forth in the share context 16. This process is repeated for each additional page view in the stack 46.

The mobile application function sharing presented above is implemented using NFC. However, other communication protocols may be used to transmit the share context 16 between mobile devices. For example, Bluetooth, which also provides short-range communication, may be used. In this case, the sending and receiving mobile devices must be paired prior to communicating the share context 16 between the mobile devices. Although NFC operates at slower speeds than Bluetooth, it consumes far less power and doesn't require pairing. Other communication protocols, both short and long-range (e.g. WiFi, cellular, etc.), capable of transmitting a share context 16 between mobile devices may also be used.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the program product of the present invention may be manually loaded directly in a computer system via a storage medium such as a CD, DVD, etc., the program product may also be automatically or semi-automatically deployed into a computer system by sending the program product to a central server or a group of central servers. The program product may then be downloaded into client computers that will execute the program product. Alternatively the program product may be sent directly to a client system via e-mail. The program product may then either be detached to a directory or loaded into a directory by a button on the e-mail that executes a program that detaches the program product into a directory. Another alternative is to send the program product directly to a directory on a client computer hard drive.

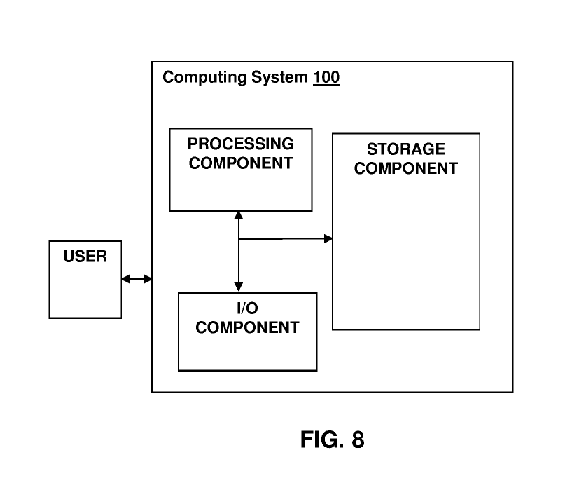

FIG. 8 depicts an illustrative processing system 100 (e.g., within a mobile device) for implementing the present invention, according to embodiments. The processing system 100 may comprise any type of computing device and, and for example includes at least one processor, memory, an input/output (I/O) (e.g., one or more I/O interfaces and/or devices), and a communications pathway. In general, processor(s) execute program code, which is at least partially fixed in memory. While executing program code, processor(s) can process data, which can result in reading and/or writing transformed data from/to memory and/or I/O for further processing. The pathway provides a communications link between each of the components in processing system 100. I/O can comprise one or more human I/O devices, which enable a user to interact with processing system 100.

The various embodiments discussed herein can offer several technical and commercial advantages, some of which are discussed herein by way of example. Embodiments of the present disclosure can eliminate the deficiencies suffered by the reactive network bandwidth balancing techniques employed by the prior art. Furthermore, embodiments of the method discussed herein can be used to automatically balance network bandwidth to minimize the over/under subscribing of network resources.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual skilled in the art are included within the scope of the invention as defined by the accompanying claims.

What is claimed is:

1. A system for mobile application function sharing, comprising:
a plurality of mobile devices; and
an application on each of the mobile devices;
wherein the application on each of the mobile devices includes a share context framework, including:
a view interface for generating a share context including a sequence of page views of content of the application;
a sender interface for transmitting the generated share context directly to the application on another of the plurality of mobile devices;
a receiver interface for receiving, directly from the application on another of the plurality of mobile devices, a share context including a sequence of page views of content of the application on the other mobile device; and
an executor for rendering in the application the sequence of page views included in the received share context.

2. The system according to claim 1, wherein the share context framework of the application on each of the plurality of mobile devices further comprises a communication system for performing the transmitting and receiving.

3. The system according to claim 2, wherein the communication system includes a near field communication system.

4. The system according to claim 1, wherein the receiver interface is further configured to:
validate the received share context; and
trigger the executor to render in the application the sequence of page views included in the received share context.

5. The system according to claim 1, wherein the view interface is further configured to parse the received share context to obtain the sequence of page views.

6. The system according to claim 5, wherein the sequence of page views of the received share context are stored in a stack, and wherein the executor is further configured to pop and render each page view in sequence from the stack.

7. The system according to claim 1, wherein the share context further includes page view sequence data, user settings for the application, a name of the application, a version of the application, and an operating system of the application.

9. A system for mobile application function sharing, comprising:
a plurality of mobile devices; and
an application on each of the mobile devices;
wherein the application on each of the mobile devices includes a share context framework for:
generating a share context including a sequence of page views of content of the application; and
transmitting the generated share context directly to the application on another of the plurality of mobile devices via near field communication.

10. The system according to claim 9, wherein the share context framework is further configured to:
receive, directly from the application on another of the plurality of mobile devices via near field communication, a share context including a sequence of page views of content of the application on the other mobile device.

11. The system according to claim 10, wherein the share context framework is further configured to render in the application the sequence of page views included in the received share context.

12. The system according to claim 11, wherein the share context framework is further configured to:
validate the received share context; and
trigger the rendering in the application of the sequence of page views included in the received share context.

13. The system according to claim 11, wherein the share context framework is further configured to parse the received share context to obtain the sequence of page views.

14. The system according to claim 13, wherein the sequence of page views of the received share context are stored in a stack, and wherein the share context framework is further configured to pop and render each page view in sequence from the stack.

15. The system according to claim 9, wherein the share context further includes page view sequence data, user settings for the application, a name of the application, a version of the application, and an operating system of the application.

16. A method for mobile application function sharing, comprising:
generating, on a first mobile device, a share context including a sequence of page views of content of an application on the first mobile device; and
transmitting the generated share context directly to the same application on a second mobile device via near field communication.

17. The method of claim 16, further comprising:
receiving, directly from the application on the second mobile device via near field communication, a share context including a sequence of page views of content of the application on the second mobile device; and
rendering in the application on the first mobile device the sequence of page views included in the received share context.

18. The method of claim 17, further comprising:
validating the received share context; and
triggering the rendering in the application of the sequence of page views included in the received share context.

19. The method according to claim 17, further comprising parsing the received share context to obtain the sequence of page views.
